(19) United States
(12) Patent Application Publication
(10) Pub. No.: US 2026/0253939 A1
(43) Pub. Date: Aug. 27, 2026

(54) Method for Manufacturing Wound Cell, Wound Cell and Battery

(71) Applicant: ZHEJIANG LIWINON ENERGY TECHNOLOGY CO., LTD., Jinhua, Zhejiang (CN)

(72) Inventors: Yu Zhang, Jinhua, Zhejiang (CN); Shuwei Tian, Jinhua, Zhejiang (CN); Yonghui Qu, Jinhua, Zhejiang (CN); Cong Li, Jinhua, Zhejiang (CN); Rongjin Ji, Jinhua, Zhejiang (CN); Shilong Wang, Jinhua, Zhejiang (CN); Jie Chen, Jinhua, Zhejiang (CN); Mingqing Zheng, Jinhua, Zhejiang (CN)

(21) Appl. No.: 19/160,152

(22) PCT Filed: Dec. 18, 2023
(86) PCT No.: PCT/CN2023/139499

§ 371 Date: Aug. 27, 2025

(30) Foreign Application Priority Data
May 25, 2023 (CN) 202310611548.9

(51) Int. Cl. H01M 10/04

(52) U.S. Cl. CPC H01M 10/0431

(57) ABSTRACT

Disclosed is a method for manufacturing a wound battery cell including the following steps covering and welding two metal sheets respectively onto the two conductive layers of a same composite current collector; after covering and welding the two metal sheets respectively onto the two conductive layers, cutting the two metal sheets respectively to form a plurality of metal sub-sheets, and then winding the metal sheets and the composite current collector together, such that each of the metal sub-sheets includes a stacking portion and a protruding portion, the stacking portion is configured to cover the conductive layer, and the protruding portion protrudes out of an edge of the tab portion; and welding the metal strip tab and all the protruding portions of the same composite current collector.

### CROSS-REFERENCE TO RELATED APPLICATIONS

This application is the United States national phase of International Patent Application No. PCT/CN2023/139499 filed Dec. 18, 2023, and claims priority to Chinese Patent Application No. 202310611548.9 filed May 25, 2023, the disclosures of which are hereby incorporated by reference in their entireties.

### BACKGROUND

### Technical Field

The present disclosure relates to the technical field of batteries, and in particular to a method for manufacturing a wound battery cell, a wound battery cell, and a battery.

### Technical Considerations

In the related technologies, composite current collectors have the advantages such as light weight and high safety. Therefore, in the manufacture of some wound battery cells, their cell bodies would be completely made of composite current collectors coated with an active material.

The composite current collector comprises a polymer material layer and conductive layers on both sides of the polymer material layer. The polymer material layer endows the composite current collector with the advantages such as light weight and high safety. However, the polymer material layer also blocks and separates the conductive layers on both sides, thus preventing the conductive layers on both sides from conducting each other. In this case, all the pseudo tabs of the wound battery would not be connected in parallel, resulting in a high internal resistance of the wound battery cell.

### SUMMARY

The present disclosure aims to solve at least one of the technical problems in the existing technologies. In view of this, the present disclosure provides a method for manufacturing a wound battery cell, which enables adjacent conductive layers of a composite current collector to communicate with each other, thereby reducing the internal resistance of the wound battery cell.

The present disclosure further provides a wound battery cell.

The present disclosure further provides a battery.

In accordance with a first non-limiting aspect of the present disclosure, a method for manufacturing a wound battery cell is provided, which is used for connecting a wound battery cell and a metal strip tab, wherein the wound battery cell is formed by winding a plurality of composite current collectors, and each of the composite current collectors comprises a tab portion; a plurality of the tab portions are arranged at intervals in a length direction of each of the composite current collectors, and each of the tab portions comprises a polymer material layer and two conductive layers which are stacked; and the two conductive layers are respectively provided at two sides of the polymer material layer; and
wherein the method for manufacturing the wound battery cell comprises the following steps:
covering and welding two metal sheets respectively onto the two conductive layers of a same composite current collector;
after covering and welding the two metal sheets respectively onto the two conductive layers, cutting the two metal sheets respectively to form a plurality of metal sub-sheets, and then winding the metal sheets and the composite current collector together, such that each of the metal sub-sheets comprises a stacking portion and a protruding portion, the stacking portion is configured to cover the conductive layer, and the protruding portion protrudes out of an edge of the tab portion; and
welding the metal strip tab and all the protruding portions of the same composite current collector.

The method for manufacturing the wound battery cell according to the non-limiting embodiments of the present disclosure has at least the following beneficial effects: by welding the metal sheet to the tab portion of the composite current collector, the stacking portion of the metal sub-sheet is welded to the conductive layer, and two adjacent metal sub-sheets are welded with each other. Further, the adjacent conductive layers are connected with each other through the stacking portion. After all the protruding portions are connected with each other, the metal strip tab is connected to the protruding portions, thus enabling the communication between an external current and all the conductive layers. By means of the method for manufacturing the wound battery cell, the adjacent conductive layers of the composite current collector can be communicated with each other, thereby reducing the internal resistance of the wound battery cell.

According to the method for manufacturing the wound battery cell in some non-limiting embodiments of the present disclosure, the step of cutting the two metal sheets respectively further comprises: making the protruding portion protrude relative to the tab portion in a width direction of the wound battery cell.

According to the method for manufacturing the wound battery cell in some non-limiting embodiments of the present disclosure, before welding the metal strip tab and the protruding portions, the method further comprises: inserting the metal strip tab between two adjacent protruding portions.

In accordance with a first non-limiting aspect of the present disclosure, a method for manufacturing a wound battery cell is provided, which is used for connecting a wound battery cell and a metal strip tab, wherein the wound battery cell is formed by winding a plurality of composite current collectors, and each of the composite current collectors comprises a tab portion and a main body portion; a plurality of the tab portions are arranged at intervals in a length direction of each of the composite current collectors, and each of the tab portions comprises a polymer material layer and two conductive layers which are stacked; the two conductive layers are respectively provided at two sides of the polymer material layer; and the wound battery cell further comprises a metal sub-sheet, the metal sub-sheet comprises a stacking portion and a protruding portion, the stacking portion is configured to cover the conductive layer, and the protruding portion protrudes out of an edge of the conductive layer; and
wherein the method for manufacturing the wound battery cell comprises the following steps:
covering and welding the stacking portion onto the conductive layer; and
welding the metal strip tab and all the protruding portions of a same composite current collector.

The method for manufacturing the wound battery cell according to the non-limiting embodiment of the present disclosure has at least the following beneficial effects: by welding the metal sheet to the tab portion of the composite current collector, the stacking portion of the metal sub-sheet is welded to the conductive layer, and two adjacent metal sub-sheets are welded with each other. Further, the adjacent conductive layers are connected with each other through the stacking portion. After all the protruding portions are connected with each other, the metal strip tab is connected to the protruding portions, thus enabling the communication between an external current and all the conductive layers. By means of the method for manufacturing the wound battery cell, the adjacent conductive layers of the composite current collector can be communicated with each other, thereby reducing the internal resistance of the wound battery cell.

According to the method for manufacturing the wound battery cell in some non-limiting embodiments of the present disclosure, cutting the two metal sheets respectively further comprises: making the protruding portion protrude relative to the tab portion in a width direction of the wound battery cell.

According to the method for manufacturing the wound battery cell in some non-limiting embodiments of the present disclosure, before welding the metal strip tab and the protruding portions, the method further comprises: inserting the metal strip tab between two adjacent protruding portions.

In accordance with a second non-limiting aspect of the present disclosure, a wound battery cell is provided, which is formed by winding a plurality of composite current collectors; wherein the wound battery cell comprises:
the composite current collectors, each comprising a tab portion and a main body portion; wherein a plurality of the tab portions are arranged at intervals in a length direction of each of the composite current collectors, and each of the tab portions comprises a polymer material layer and two conductive layers which are stacked; and the two conductive layers are respectively provided at two sides of the polymer material layer;
a metal sub-sheet, comprising a stacking portion and a protruding portion; wherein the stacking portion is configured to cover the conductive layer, and the protruding portion protrudes out of an edge of the conductive layer; and all the protruding portions are connected with each other; and
a metal strip tab welded to the protruding portion.

The wound battery cell according to the non-limiting embodiments of the present disclosure has at least the following beneficial effects: by welding the metal sheet to the tab portion of the composite current collector, the stacking portion of the metal sub-sheet is welded to the conductive layer, and two adjacent metal sub-sheets are welded with each other. Further, the adjacent conductive layers are connected with each other through the stacking portion. After all the protruding portions are connected with each other, the metal strip tab is connected to the protruding portions, thus enabling the communication between an external current and all the conductive layers. By means of the wound battery cell, the adjacent conductive layers of the composite current collector can be communicated with each other, thereby reducing the internal resistance of the wound battery cell.

According to the wound battery cell in some non-limiting embodiments of the present disclosure, the protruding portion protrudes relative to the tab portion in a width direction of the wound battery cell.

According to the wound battery cell in some non-limiting embodiments of the present disclosure, the metal strip tab is provided between two adjacent protruding portions.

In accordance with a third non-limiting aspect of the present disclosure, a battery is provided, which comprises the wound battery cell according to any one of the non-limiting embodiments of the second aspect.

The battery according to the non-limiting embodiments of the present disclosure has at least the following beneficial effects: by welding the metal sheet to the tab portion of the composite current collector, the stacking portion of the metal sub-sheet is welded to the conductive layer, and two adjacent metal sub-sheets are welded with each other. Further, the adjacent conductive layers are connected with each other through the stacking portion. After all the protruding portions are connected with each other, the metal strip tab is connected to the protruding portions, thus enabling the communication between an external current and all the conductive layers. By means of the wound battery cell, the adjacent conductive layers of the composite current collector can be communicated with each other, thereby reducing the internal resistance of the wound battery cell. Further, the battery comprising such wound battery cell possesses reduced internal resistance.

Additional non-limiting aspects and advantages of the present disclosure will be set forth in part in the description below and in part will be obvious from the description below, or will be learned by the practice of the present disclosure.

### BRIEF DESCRIPTION OF THE DRAWINGS

The present disclosure will be further described with reference to the accompanying drawings and the examples, wherein:

FIG. 1 is a schematic diagram of a composite current collector in the method for manufacturing the wound battery cell according to a first non-limiting embodiment of the present disclosure;

FIG. 2 is a schematic diagram of a composite current collector in the method for manufacturing the wound battery cell according to a second non-limiting embodiment of the present disclosure;

FIG. 3 is a schematic diagram of a metal sheet connected to a composite current collector in the method for manufacturing the wound battery cell according to a third non-limiting embodiment of the present disclosure;

FIG. 4 is a schematic view from another view of FIG. 3;

FIG. 5 is a cross-sectional view of a metal strip tab connected to a composite current collector in a wound battery cell according to a fourth non-limiting embodiment of the present disclosure;

FIG. 6 is a schematic diagram of a wound battery cell according to a fifth non-limiting embodiment of the present disclosure;

FIG. 7 is a schematic diagram of a metal strip tab connected to a composite current collector in a wound battery cell according to a sixth non-limiting embodiment of the present disclosure;

FIG. 8 is a side view of a wound battery cell according to a seventh non-limiting embodiment of the present disclosure;

FIG. 9 is a top view of a wound battery cell according to an eighth non-limiting embodiment of the present disclosure; and

FIG. 10 is a top view of a wound battery cell according to a ninth non-limiting embodiment of the present disclosure

### REFERENCE SIGNS

Wound battery cell 100, composite current collector 200, main body portion 210, tab portion 220, polymer material layer 221, conductive layer 222, ceramic layer 230, metal sheet 300, metal sub-sheet 310, stacking portion 311, protruding portion 312, and metal strip tab 400.

### DETAILED DESCRIPTION

The embodiments of the present disclosure will be described in detail hereinafter, the examples of which are illustrated in the accompanying drawings, wherein the same or similar reference signs are used to indicate the same or similar elements or the elements having the same or similar functions. The embodiments described below with reference to the accompanying drawings are exemplary and are provided only for the purpose of illustration, and are not intended to limit the present disclosure.

In the description of the present disclosure, it should be understood that the orientation descriptions related to position or positional relationship, such as top, bottom, front, back, left, right, and the like, are based on the position or positional relationship shown in the accompanying drawings, and are only used for the convenience of illustrating the present disclosure and simplifying the description, and are not necessarily intended to indicate or imply that the referred unit or element must have a specific orientation or must be constructed and operated in a specific orientation, and therefore should not be understood as a limitation of the present disclosure.

In the description of the present disclosure, “several” means “one or more”, “more” means “two or more”, and “more than”, “less than”, “exceeding” and so on are understood to exclude the referred value, and “higher”, “lower” and “inclusive” are understood to include the referred value. If used, the reference to “first”, “second”, and so on is only for distinguishing the technical features, and it should not be understood as indicating or implying the relative importance or implying the number of the indicated technical features or implying the sequence of the indicated technical features.

In the description of the present disclosure, unless otherwise specified, the words such as “provide”, “arrange”, “connect”, and so on should be understood in a broad sense, and those skilled in the art can reasonably determine the specific meanings of the above words in the present disclosure according to the specific technical solutions.

In the description of the present disclosure, the description with reference to the terms “one embodiment”, “some embodiments”, “exemplary embodiments”, “an example”, “specific example” or “some examples” means that the specific feature, structure, material or characteristic described in connection with the embodiment or example is included in at least one embodiment or example of the present disclosure. In the description of the present disclosure, the exemplary mentions of the above terms do not necessarily refer to the same embodiment or example. Moreover, the specific feature, structure, material or characteristic described may be combined in any one or more embodiments or examples in a suitable manner.

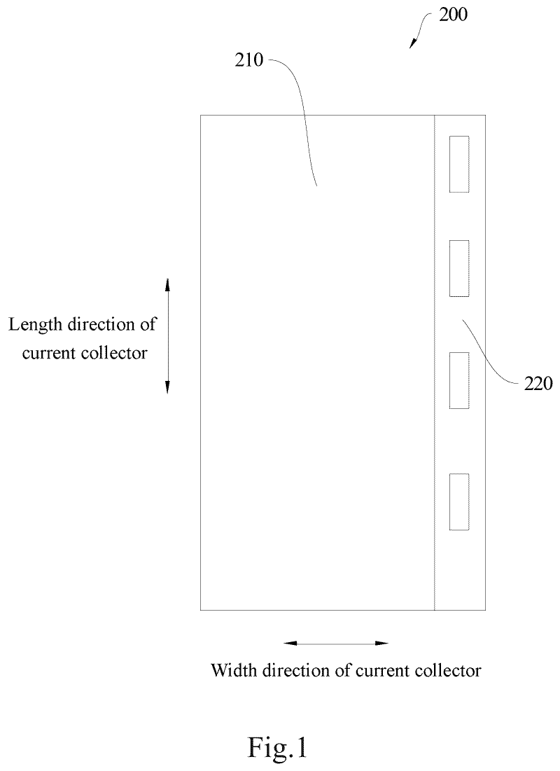

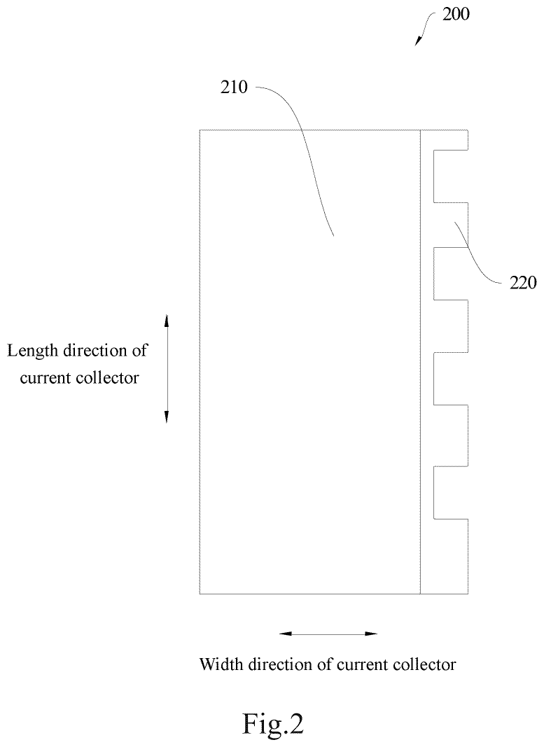

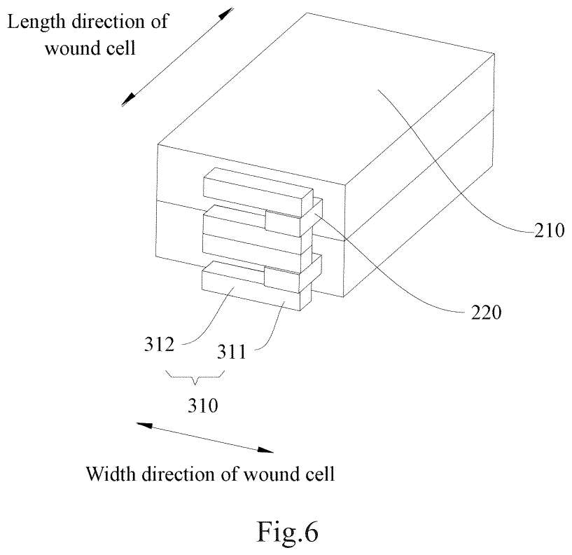

In some non-limiting embodiments, a method for manufacturing a wound battery cell 100 is provided, which is used for connecting the wound battery 100 and a metal strip tab 400, wherein the wound battery cell 100 is formed by winding a plurality of composite current collectors 200. That is, the composite current collectors 200 are stacked on each other, and then wound together. Referring to FIG. 6, it shows the form of the composite current collectors 200 after winding. Referring to FIG. 1 and FIG. 2, they are schematic diagrams respectively showing the composite current collectors 200 before winding. Each of the composite current collectors 200 comprises a main body portion 210 and a tab portion 220. The main body portion 210 is coated with an active material, and the tab portion 220 is connected to one end of the main body portion 210. A plurality of tab portions 220 are arranged at intervals in a length direction of each of the composite current collectors 200, and each of the tab portions 220 comprises a polymer material layer 221 and two conductive layers 222 which are stacked, and the two conductive layers 222 are respectively provided on two sides of the polymer material layer 221.

The method for manufacturing the wound battery cell 100 comprises the following steps:
S100: covering and welding two metal sheets 300 respectively onto the two conductive layers 222 of a same composite current collector 200;
S200: after covering and welding the two metal sheets 300 respectively onto the two conductive layers 222, cutting the two metal sheets 300 respectively to form a plurality of metal sub-sheets 310, and then winding the metal sheets 300 and the composite current collector 200 together, such that each of the metal sub-sheets 310 comprises a stacking portion 311 and a protruding portion 312, the stacking portion 311 is configured to cover the conductive layer 222, and the protruding portion 312 protrudes out of an edge of the tab portion 220; and
S300: welding the metal strip tab 400 and all the protruding portions 312 of the same composite current collector 200.

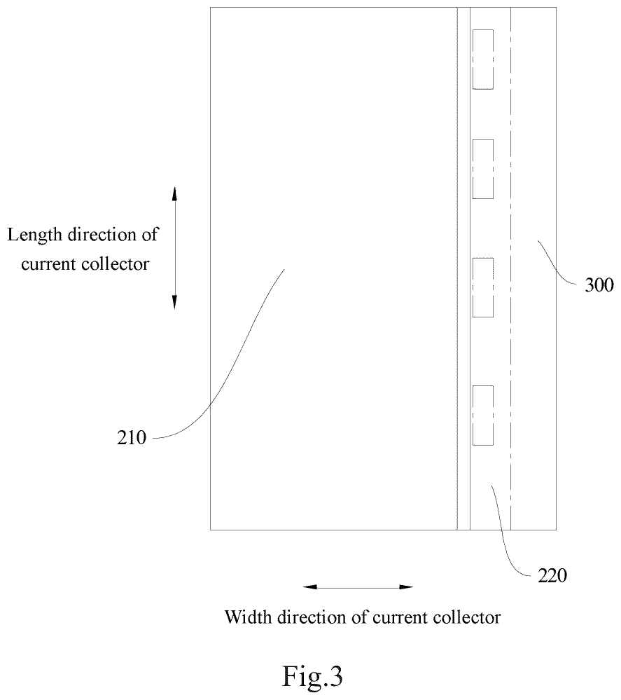

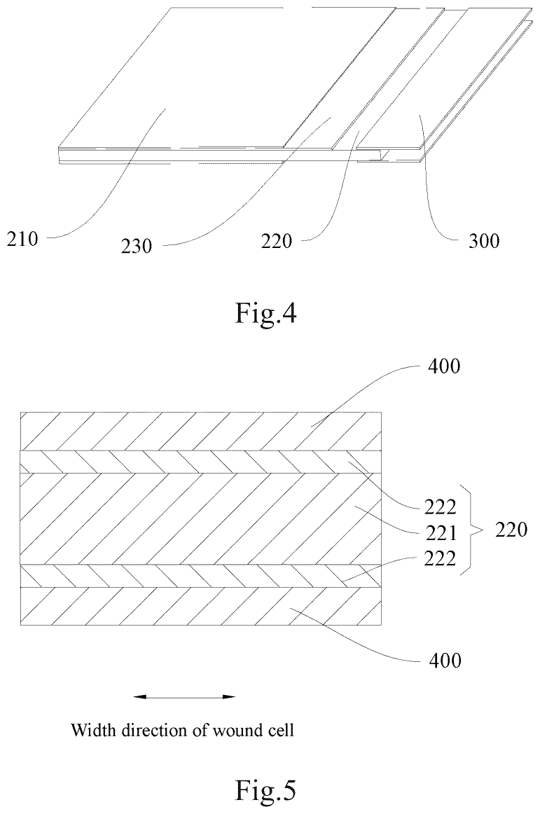

Specifically, referring to FIG. 1, FIG. 3 and FIG. 4, which illustrate a manufacturing process of the wound battery cell 100. FIG. 6 is a schematic diagram of the composite current collectors 200 after winding. After the metal sheets 300 are welded to the tab portion 220 of the composite current collector 200, the stacking portion 311 of the metal sub-sheet 310 is welded to the conductive layer 222, and two adjacent metal sub-sheets 310 are welded to each other. Further, the adjacent conductive layers 222 are connected with each other through the stacking portion 311. Referring to FIG. 5, after all the protruding portions 312 are connected with each other, the metal strip tab 400 is connected to the protruding portions 312, thus enabling the communication between an external current and all the conductive layers 222. By means of the method for manufacturing the wound battery cell 100, the adjacent conductive layers 222 of the composite current collector 200 can be communicated with each other, thereby reducing the internal resistance of the wound battery cell 100.

It should be noted that the step of welding the metal strip tab 400 and all the protruding portions 312 of the same composite current collector 200 may specifically be performed by welding the ends on the same side of the protruding portion 312 of each of the metal sub-sheets 310 at a common point, and then connecting the metal strip tab 400 at this point. By this way, a current can enter all the protruding portions 312 through the metal strip tab 400, and vice versa. Alternatively, the step of welding the metal strip tab 400 and all the protruding portions 312 of the same composite current collector 200 may also be specifically performed by connecting all the protruding portions 312 using a metal adapter, and then connecting the metal adapter to the metal strip tab 400. In addition, the step of welding the metal strip tab 400 and all the protruding portions 312 of the same composite current collector 200 may specifically be performed by stacking and bending all the protruding portions 312 and the metal strip tab 400 together, and then welding at a common point. Alternatively, the step of welding the metal strip tab 400 and all the protruding portions 312 of the same composite current collector 200 may also be specifically performed by stacking all the protruding portions 312, welding the metal strip tab 400 on the protruding portions 312, and then bending all the protruding portions 312 and the metal strip tab 400.

It should be noted that welding the metal strip tab 400 and all the protruding portions 312 of the same composite current collector 200 may specifically involve that there are two composite current collectors 200 which are coated with different active materials, thus serving as a cathode and an anode, respectively, of the wound battery cell 100. There are two metal strip tabs 400, which are respectively connected to two composite current collectors 200. That is, one metal strip tab 400 is welded to all the protruding portions 312 of a cathode composite current collector 200, and the other metal strip tab 400 is welded to all the protruding portions 312 of an anode composite current collector 200.

Referring to FIG. 4, a ceramic layer 230 may be further provided between the main body portion 210 and the tab portion 220, thereby improving the safety performance of the wound battery cell 100.

Referring to FIG. 6, in some non-limiting embodiments, the step of cutting the two metal sheets 300 respectively further comprises: making the protruding portion 312 protrude relative to the tab portion 220 in a width direction of the wound battery cell 100. Specifically, the phrase “the protruding portion 312 protrudes out of an edge of the tab portion 220” may specifically refer to the protruding portion 312 protrudes beyond the edge of the tab portion 220, in a width direction of the wound battery cell 100 or in a length direction of the wound battery cell 100. Compared with the protruding portion 312 protruding beyond the conductive layer 222 in a length direction of the wound battery cell 100 which may extend the length of the wound battery cell 100, the protruding portion 312 protruding beyond the conductive layer 222 in a width direction of the wound portion cell 100 would not increase the length of the wound battery cell 100.

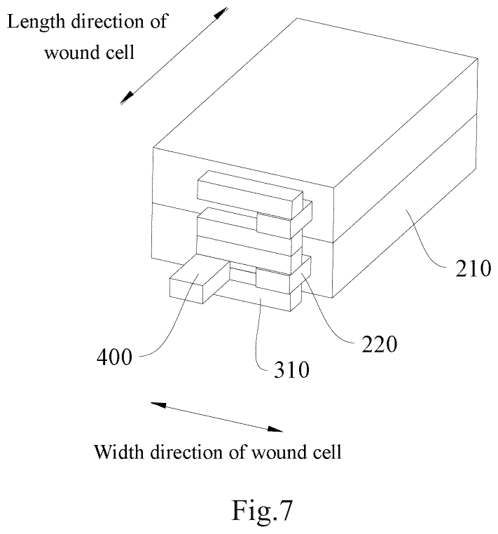

Referring to FIG. 7, in some non-limiting embodiments, before welding the metal strip tab 400 and the protruding portions 312, the method further comprises inserting the metal strip tab 400 between two adjacent protruding portions 312. Specifically, the metal strip tab 400 may be welded to an outside of the protruding portion 312 in a thickness direction of the main body portion 210. However, after the metal strip tab 400 is connected to the metal sub-sheet 310, if the metal strip tab 400 is connected to the outside of the protruding portion 312, a thickness of a welding position between the protruding portion 312 and the metal strip tab 400 may increase and thus exceed a thickness of the main body portion 210. When the thickness of the welding position exceeds the thickness of the main body portion 210, the energy density of the wound battery cell 100 would be lower, or the wound battery cell 100 is incompatible when placed in an aluminum-plastic film or a steel case. Therefore, by inserting the metal strip tab 400 between two adjacent protruding portions 312, there is no risk of increasing the thickness of the welding position when the metal strip tab 400 is welded to the protruding portion 312, thus facilitating the wound battery cell 100 to be more compatible with the aluminum-plastic film or the steel case.

In addition to the above-described method for manufacturing the wound battery cell 100, another method for manufacturing the wound battery cell 100 is provided. Referring to FIG. 1, FIG. 3 and FIG. 4, which illustrate a manufacturing process of the wound battery cell 100. FIG. 6 is a schematic diagram of the composite current collectors 200 after winding. In some non-limiting embodiments, the method for manufacturing the wound battery cell 100 is used for connecting the wound battery 100 and a metal strip tab 400, wherein the wound battery cell 100 is formed by winding a plurality of composite current collectors 200. Each of the composite current collectors 200 comprises a main body portion 210 and a tab portion 220. The main body portion 210 is coated with an active material, and the tab portion 220 is connected to one end of the main body portion 210. A plurality of tab portions 220 are arranged at intervals in a length direction of each of the composite current collectors 200, and each of the tab portions 220 comprises a polymer material layer 221 and two conductive layers 222 which are stacked, and the two conductive layers 222 are respectively provided on two sides of the polymer material layer 221. The wound battery cell 100 further comprises a metal sub-sheet 310, the metal sub-sheet 310 comprises a stacking portion 311 and a protruding portion 312, the stacking portion 311 is configured to cover the conductive layer 222, and the protruding portion 312 protrudes out of an edge of the conductive layer 222.

The method for manufacturing the wound battery cell 100 comprises the following steps:
S100: covering and welding the stacking portion 311 on the conductive layer 222; and
S200: welding the metal strip tab 400 and all the protruding portions 312 of a same composite current collector 200.

Specifically, referring to FIG. 6, after the metal sheets 300 are welded to the tab portion 220 of the composite current collector 200, the stacking portion 311 of the metal sub-sheet 310 is welded to the conductive layer 222, and two adjacent metal sub-sheets 310 are welded to each other. Further, the adjacent conductive layers 222 are connected with each other through the stacking portion 311. After all the protruding portions 312 are connected with each other, the metal strip tab 400 is connected to the protruding portions 312, thus enabling the communication between an external current and all the conductive layers 222. By means of the method for manufacturing the wound battery cell 100, the adjacent conductive layers 222 of the composite current collector 200 can be communicated with each other, thereby reducing the internal resistance of the wound battery cell 100.

It should be noted that the step of welding the metal strip tab 400 and all the protruding portions 312 of the same composite current collector 200 may specifically be performed by welding the ends on the same side of the protruding portion 312 of each of the metal sub-sheets 310 at a common point, and then connecting the metal strip tab 400 at this point. By this way, a current can enter all the protruding portions 312 through the metal strip tab 400, and vice versa. Alternatively, the step of welding the metal strip tab 400 and all the protruding portions 312 of the same composite current collector 200 may also be specifically performed by connecting all the protruding portions 312 using a metal adapter, and then connecting the metal adapter to the metal strip tab 400. In addition, the step of welding the metal strip tab 400 and all the protruding portions 312 of the same composite current collector 200 may specifically be performed by stacking and bending all the protruding portions 312 and the metal strip tab 400 together, and then welding.

Referring to FIG. 6, in some non-limiting embodiments, the step of cutting the two metal sheets 300 respectively further comprises: making the protruding portion 312 protrude relative to the tab portion 220 in a width direction of the wound battery cell 100. Specifically, the phrase the protruding portion 312 protrudes out of an edge of the tab portion 220” may specifically refer to the protruding portion 312 protrudes beyond the edge of the tab portion 220, in a width direction of the wound battery cell 100 or in a length direction of the wound battery cell 100. Compared with the protruding portion 312 protruding beyond the conductive layer 222 in a length direction of the wound battery cell 100 which may extend a length of the wound battery cell 100, the protruding portion 312 protruding beyond the conductive layer 222 in a width direction of the wound portion cell 100 would not increase a length of the wound battery cell 100.

Referring to FIG. 7, in some non-limiting embodiments, before welding the metal strip tab 400 and the protruding portions 312, the method further comprises inserting the metal strip tab 400 between two adjacent protruding portions 312. Specifically, the metal strip tab 400 may be welded to an outside of the protruding portion 312 in a thickness direction of the main body portion 210. However, after the metal strip tab 400 is connected to the metal sub-sheet 310, if the metal strip tab 400 is connected to the outside of the protruding portion 312, a thickness of a welding position between the protruding portion 312 and the metal strip tab 400 may increase and thus exceed a thickness of the main body portion 210. When the thickness of the welding position exceeds the thickness of the main body portion 210, the energy density of the wound battery cell 100 would be lower, or the wound battery cell 100 is incompatible when placed in a battery compartment of an electronic device. Therefore, by inserting the metal strip tab 400 between two adjacent protruding portions 312, there is no risk of increasing the thickness of the welding position when the metal strip tab 400 is welded to the protruding portion 312, thus facilitating the wound battery cell 100 to be more compatible with the battery compartment.

The structure of the wound battery cell 100 will be described hereafter. Referring to FIG. 6, in some non-limiting embodiments, the wound battery cell 100 is formed by winding a plurality of composite current collectors 200, and wound battery cell 100 comprises: the composite current collectors 200, a metal sub-sheet 310 and a metal strip tab 400. Each of the composite current collectors 200 comprises a main body portion 210 and a tab portion 220. The main body portion 210 is coated with an active material, and the tab portion 220 is connected to one end of the main body portion 210. A plurality of tab portions 220 are arranged at intervals in a length direction of each of the composite current collector 200, and each of the tab portions 220 comprises a polymer material layer 221 and two conductive layers 222 which are stacked, and the two conductive layers 222 are respectively provided on two sides of the polymer material layer 221. The metal sub-sheet 310 comprises a stacking portion 311 and a protruding portion 312, the stacking portion 311 is configured to cover the conductive layer 222, and the protruding portion 312 protrudes out of an edge of the conductive layer 222; and all the protruding portions 312 are connected with each other. The metal strip tab 400 is welded to the protruding portion 312.

Specifically, after the metal sheets 300 are welded to the tab portion 220 of the composite current collector 200, the stacking portion 311 of the metal sub-sheet 310 is welded to the conductive layer 222, and two adjacent metal sub-sheets 310 are welded to each other. Further, the adjacent conductive layers 222 are connected with each other through the stacking portion 311. After all the protruding portions 312 are connected with each other, the metal strip tab 400 is connected to the protruding portions 312, thus enabling the communication between an external current and all the conductive layers 222. By means of the method for manufacturing the wound battery cell 100, the adjacent conductive layers 222 of the composite current collector 200 can be communicated with each other, thereby reducing the internal resistance of the wound battery cell 100.

Referring to FIG. 6, in some non-limiting embodiments, the protruding portion 312 protrudes relative to the tab portion 220 in a width direction of the wound battery cell 100. Specifically, the phrase “the protruding portion 312 protrudes out of an edge of the tab portion 220” may specifically refer to the protruding portion 312 protrudes beyond the edge of the tab portion 220, in a width direction of the wound battery cell 100 or in a length direction of the wound battery cell 100. Compared with the protruding portion 312 protruding beyond the conductive layer 222 in a length direction of the wound battery cell 100 which may extend a length of the wound battery cell 100, the protruding portion 312 protruding beyond the conductive layer 222 in a width direction of the wound portion cell 100 would not increase a length of the wound battery cell 100.

Referring to FIG. 7, in some non-limiting embodiments, the metal strip tab 400 is provided between two adjacent protruding portions 312. Specifically, the metal strip tab 400 may be welded to an outside of the protruding portion 312 in a thickness direction of the main body portion 210. However, after the metal strip tab 400 is connected to the metal sub-sheet 310, if the metal strip tab 400 is connected to the outside of the protruding portion 312, a thickness of a welding position between the protruding portion 312 and the metal strip tab 400 may increase and thus exceed a thickness of the main body portion 210. When the thickness of the welding position exceeds the thickness of the main body portion 210, the energy density of the wound battery cell 100 would be lower, or the wound battery cell 100 is incompatible when placed in a battery compartment of an electronic device. Therefore, by inserting the metal strip tab 400 between two adjacent protruding portions 312, there is no risk of increasing the thickness of the welding position when the metal strip tab 400 is welded to the protruding portions 312, thus facilitating the wound battery cell 100 to be more compatible with the battery compartment.

The metal sheet 300 may be made of a conductive material with good conductivity, such as copper foil, aluminum foil, or nickel foil. The metal strip tab 400 may also be made of a conductive material with good conductivity, such as copper foil, aluminum foil, or nickel foil. When the metal strip tab 400 is made of copper foil, its thickness may range from 3 micrometer (μm) to 25 μm. When the metal strip tab 400 is made of aluminum foil, its thickness may range from 6 μm to 25 μm.

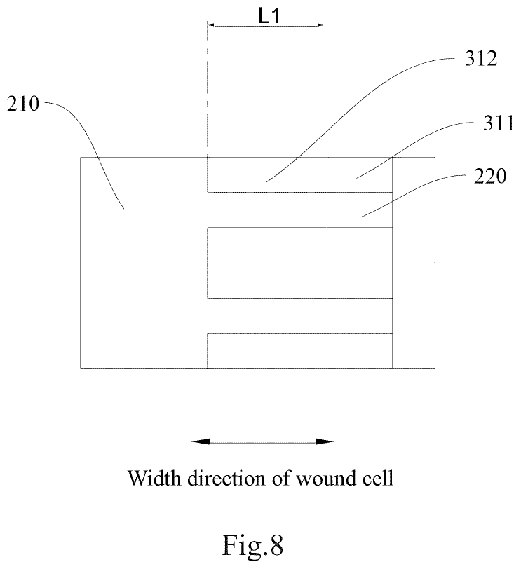

Referring to FIG. 8, in some non-limiting embodiments, the protruding portion 312 has a length of L1 in a width direction of the wound battery cell 100, and L1 is greater than or equal to 2.5 mm and less than or equal to 8 mm. If the length L1 is less than 2.5 mm, the length of the protruding portion 312 is too small for welding the protruding portion 312 with the metal strip tab 400, which increases the difficulty for workers to weld the protruding portion 312 to the metal strip tab 400. When the length L1 is greater than 8 mm, it will cause unnecessary waste of materials.

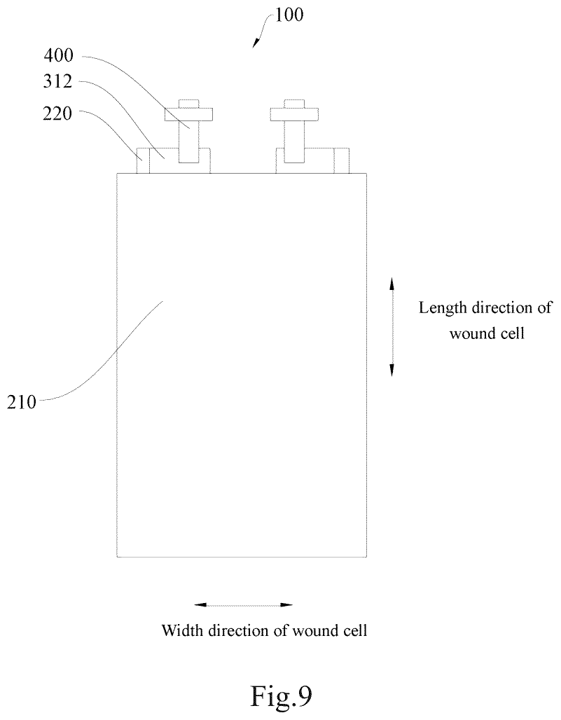

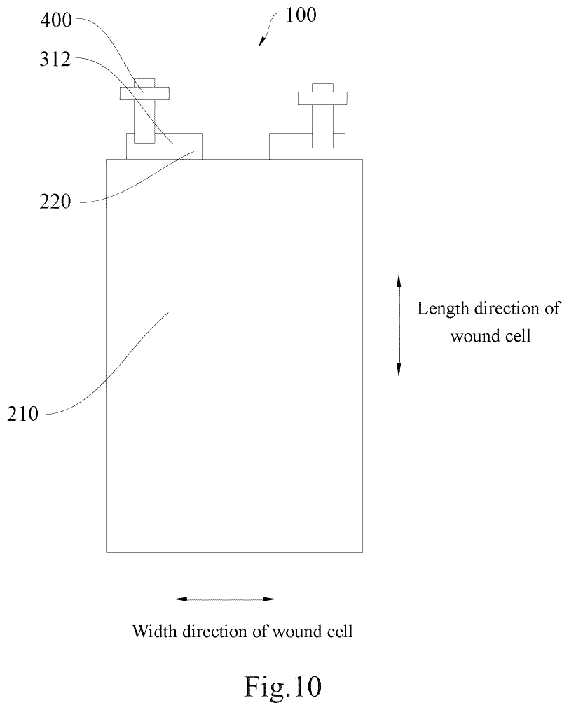

Referring to FIG. 9 and FIG. 10, in some non-limiting embodiments, the protruding portion 312 protrudes relative to the tab portion 220 in a width direction of the wound battery cell 100, wherein the protruding portion 312 may protrude inward in the width direction of the wound battery cell 100, with reference to FIG. 9. Alternatively, the protruding portion 312 may also protrude outward in the width direction of the wound battery cell 100, with reference to FIG. 10. Therefore, the wound battery cell 100 has a wider adaptability.

In some non-limiting embodiments, a battery is provided, which comprises the wound battery cell 100 of any of the above embodiments. After the metal sheets 300 are welded to the tab portion 220 of the composite current collector 200, the stacking portion 311 of the metal sub-sheet 310 is welded to the conductive layer 222, and two adjacent metal sub-sheets 310 are welded to each other. Further, the adjacent conductive layers 222 are connected with each other through the stacking portion 311. After all the protruding portions 312 are connected with each other, the metal strip tab 400 is connected to the protruding portions 312, thus enabling the communication between an external current and all the conductive layers 222. By means of the wound battery cell 100, the adjacent conductive layers 222 of the composite current collector 200 can be communicated with each other, thereby reducing the internal resistance of the wound battery cell 100. Further, the battery comprising the wound battery cell 100 also possesses reduced internal resistance.

The embodiments of the present disclosure have been described in detail with reference to the accompanying drawings, but the above embodiments are not intended to limit the scope of the present disclosure. Many variations can be made within the knowledge of those ordinary skilled in the art without departing from the purpose of the present disclosure. In addition, the embodiments and the features in embodiments of the present disclosure can be combined with each other without conflict.

1. A method for manufacturing a wound battery cell, which is used for connecting a wound battery cell and a metal strip tab, wherein the wound battery cell is formed by winding a plurality of composite current collectors, and each of the composite current collectors comprises a plurality of tab portions; the plurality of the tab portions are arranged at intervals in a length direction of each of the composite current collectors, and each of the tab portions comprises a polymer material layer and two conductive layers which are stacked; and the two conductive layers are respectively provided at two sides of the polymer material layer; and
wherein the method for manufacturing the wound battery cell comprises the following steps:
covering and welding two metal sheets respectively onto the two conductive layers of a same composite current collector;
after covering and welding the two metal sheets respectively onto the two conductive layers, cutting the two metal sheets respectively to form a plurality of metal sub-sheets, and then winding the metal sheets and the composite current collector together, such that each of the metal sub-sheets comprises a stacking portion and a protruding portion, the stacking portion is configured to cover the conductive layer, and the protruding portion protrudes out of an edge of the tab portion; and
welding the metal strip tab and all the protruding portions of the same composite current collector.

2. The method for manufacturing the wound battery cell according to claim 1, wherein, the step of cutting the two metal sheets respectively further comprises: making the protruding portion protrude relative to the tab portion in a width direction of the wound battery cell.

3. The method for manufacturing the wound battery cell according to claim 1, wherein, before welding the metal strip tab and the protruding portions, the method further comprises: inserting the metal strip tab between two adjacent protruding portions.

4. A method for manufacturing a wound battery cell, which is used for connecting a wound battery cell and a metal strip tab, wherein the wound battery cell is formed by winding a plurality of composite current collectors, and each of the composite current collectors comprises a tab portion and a main body portion; a plurality of the tab portions are arranged at intervals in a length direction of each of the composite current collectors, and each of the tab portions comprises a polymer material layer and two conductive layers which are stacked; the two conductive layers are respectively provided at two sides of the polymer material layer; and the wound battery cell further comprises a metal sub-sheet, the metal sub-sheet comprises a stacking portion and a protruding portion, the stacking portion is configured to cover the conductive layer, and the protruding portion protrudes out of an edge of the conductive layer; and
wherein the method for manufacturing the wound battery cell comprises the following steps:
covering and welding the stacking portion onto the conductive layer; and
welding the metal strip tab and all the protruding portions of a same composite current collector.

5. The method for manufacturing the wound battery cell according to claim 4, wherein, cutting the two metal sheets respectively further comprises: making the protruding portion protrude relative to the tab portion in a width direction of the wound battery cell.

6. The method for manufacturing the wound battery cell according to claim 4, wherein, before welding the metal strip tab and the protruding portions, the method further comprises: inserting the metal strip tab between two adjacent protruding portions.

7. A wound battery cell, which is formed by winding a plurality of composite current collectors; wherein the wound battery cell comprises:
the composite current collectors, each comprising a tab portion and a main body portion; wherein a plurality of the tab portions are arranged at intervals in a length direction of each of the composite current collectors, and each of the tab portions comprises a polymer material layer and two conductive layers which are stacked; and the two conductive layers are respectively provided at two sides of the polymer material layer;
a metal sub-sheet, comprising a stacking portion and a protruding portion; wherein the stacking portion is configured to cover the conductive layer, and the protruding portion protrudes out of an edge of the conductive layer; and all the protruding portions are connected with each other; and
a metal strip tab welded to the protruding portion.

8. The wound battery cell according to claim 7, wherein, the protruding portion protrudes relative to the tab portion in a width direction of the wound battery cell.

9. The wound battery cell according to claim 7, wherein, the metal strip tab is provided between two adjacent protruding portions.

10. A battery, comprising the wound battery cell according to claim 7.

11. A battery, comprising the wound battery cell according to claim 8.

12. A battery, comprising the wound battery cell according to claim 9.
